(19) United States
(12) Patent Application Publication
(10) Pub. No.: US 2003/0060585 A1
(43) Pub. Date: Mar. 27, 2003

(54) Process for polymerizing alpha-olefins

(75) Inventors: Karunakaran Radhakrishnan, Minneapolis, MN (US); Henri Cramail, Sainte Terre (FR); Alain Deffieux, Bordeaux (FR); Philippe Francois, Court-St-Etienne-Faux (BE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SOLVAY POLYOLEFINS EUROPE-BELGIUM, BRUSSELS (BE)

(21) Appl. No.: 10/189,508

(22) Filed: Jul. 8, 2002

(30) Foreign Application Priority Data
Jul. 9, 2001 (EP) 01202624.1

(51) Int. Cl. C08F 4/06

(52) U.S. Cl. 526/172

(57) ABSTRACT

Process for polymerizing α-olefins Process for polymerizing x-olefins, in which at least one α-olefin is placed in contact, under polymerizing conditions, with a catalytic system comprising

(a) at least one catalytic complex based on a transition metal (M) from groups 6 to 12 of the Periodic Table,

(b) at least one trialkylaluminium corresponding to the general formula AlR₃ in which each R independently represents an alkyl group containing from 5 to 30 carbon atoms.

The present invention relates to a process for polymerizing α-olefins.

It is known practice to polymerize α-olefins using catalytic systems comprising a complex of a transition metal with a bidentate or tridentate ligand, and an aluminoxane. Patent application WO 98/27124 describes a process for polymerizing ethylene using a catalytic system comprising a catalytic complex based on iron or cobalt with pyridinebis(imines) and methylaluminoxane. The use of an aluminoxane leads to high activities. However, the aluminoxanes are in the form of sticky oligomers and are difficult to handle and to synthesize. In addition, the aluminoxanes that are commercially available are of very variable purity and are relatively expensive and unstable.

It is also known practice to polymerize α-olefins using catalytic systems comprising a complex of a transition metal with a bidentate or tridentate ligand and a trialkylaluminium. Patent application EP 1 054 022 and also Kumar et al. (Macromol. Chem. Phys., 2000, 201 (,13), 1513) describe the polymerization of ethylene using iron-based catalysts with ligands of bis(imino)pyridine type or nickel-based catalysts with ligands of diimine type in the presence of trimethyl-aluminium (TMA) or triisobutylaluminium (TIBAL). Such catalytic systems show moderate activity, more particularly at polymerization temperatures above ambient temperature.

A process has now been found for polymerizing α-olefins using a catalytic system based on a catalyst comprising a complex of a metal from groups 6 to 12, which does not have the abovementioned drawbacks.

To this end, the present invention relates to a process for polymerizing α-olefins, in which at least one α-olefin is placed in contact, under polymerizing conditions, with a catalytic system comprising

(a) at least one catalytic complex based on a metal (M) from groups 6 to 12 of the Periodic Table,

(b) at least one trialkylaluminium corresponding to the general formula AlR₃ in which each R independently~represents an alkyl group containing from 5 to 30 carbon atoms.

All the references to the Periodic Table of the Elements refer to the version published in CRC Handbook of Chemistry and Physics, 77th Edition, 1996/97; the notation used is the new notation of the groups by IUPAC.

In the present invention, the term “α-olefins” is intended to denote terminally-unsaturated olefins containing from 2 to 20 and preferably from 2 to 8 carbon atoms, such as, especially, ethylene, propylene, 1-butene, 1-methylpentene, 1-hexene and 1-octene. It goes without saying that, besides the α-olefin, another monomer copolymerizable with the α-olefin may be used in the process according to the invention.

The catalytic complexes (a) used in the present invention are generally chosen from those containing at least two hetero atoms and more particularly from those represented by formula (I)

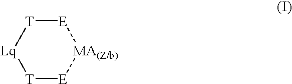

in which

M is a metal from groups 6 to 12 of the Periodic Table,

E and E′ are electron-donating groups containing an atom from group 15; E and E′ may be identical or different,

L is an electron-donating group containing an atom from group 14 to 16 or a hydrocarbon aromatic nucleus; L may be identical to or different from E and/or E′,

T and T′independently represent saturated or unsaturated bridges containing elements from groups 14 to 16,

each A independently represents an atom or a group of atoms covalently or ionically bonded to the metal M,

Z is the oxidation state of M,

b is the valency of A,

q is 1 or 0.

The preferred catalytic complexes (a) are those in which the metal (M) is chosen from the metals from groups 6 to 10. The preferred catalytic complexes (a) are those in which A is a halogen atom, an alkoxide, an aryloxide, an amine, a phosphine, a hydride or a hydrocarbon group, optionally substituted and/or halogenated.

The catalytic complexes (a) used in the present invention may optionally be complexed with one or more electron-donating groups.

The catalytic complexes (a) used in the process according to the invention are advantageously chosen from complexes corresponding to the general formula (II)

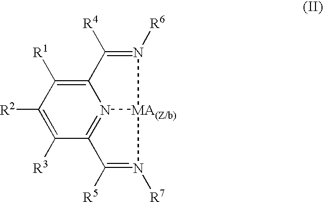

in which

M, A, Z and b are as defined for formula (I),

R¹, R² R³, R4 and R⁵ each independently represent a hydrogen atom, an optionally substituted hydrocarbon group, an optionally substituted heterohydrocarbon group or an inert functional group,

R⁶ and R⁷ each independently represent an optionally substituted aryl group.

In the context of the present invention, the expression “inert functional group” is intended to denote an atom or a group of atoms that does not interfere under the conditions of the process according to the present invention, and that does not coordinate with the metal M. Examples of inert functional groups that may be mentioned include halogen atoms and ethers of formula −OQ in which Q is an optionally substituted hydrocarbon group.

Catalytic complexes that are preferred are those represented by formula (II) in which

R⁶ is an aryl group corresponding to the general formula

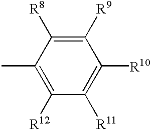

and R⁷ is an aryl group corresponding to the general formula

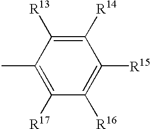

in which

R⁸ and R¹³ each independently represent an optionally substituted hydrocarbon group, an optionally substituted heterohydrocarbon group or an inert functional group,

R⁹, R¹⁰, R¹¹, R¹², R¹⁴, R¹⁵, R¹⁶ and R¹⁷ each independently represent a hydrogen atom, an optionally substituted hydrocarbon group, an optionally substituted heterohydrocarbon group or an inert functional group,

the groups R⁸, R⁹, R¹⁰, R¹¹, R¹², R¹³, R¹⁴, R¹⁵, R¹⁶ and R¹⁷ which are adjacent possibly being linked together so as to form a ring.

Such catalytic complexes have especially been described in patent application WO 98/27124.

Catalytic complexes (a) that are particularly preferred are those corresponding to formula (II) in which the metal (M) is chosen from groups 6 to 9, and more particularly those in which the metal (M) is iron, chromium or cobalt. Advantageously, A is a halogen atom and more particularly a chlorine atom.

Good results have been obtained with catalytic complexes (a) corresponding to formula (II) in which

M is an Fe atom,

A is a Cl atom,

b is equal to 1,

Z is equal to 2,

R¹, R² and R³ are hydrogen atoms,

R⁴ and R⁵ are each independently a hydrogen atom or an alkyl group containing from 1 to 6 carbon atoms,

R⁶ is an aryl group of formula

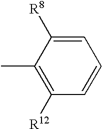

R⁷ is an aryl group of formula

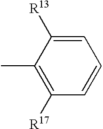

in which R⁸ and R¹³ are an alkyl group containing not more than 4 carbon atoms, and R¹² and R¹⁷ are a hydrogen atom or an alkyl group containing not more than 4 carbon atoms.

The trialkylaluminiums (b) of formula AlR₃ used in the process according to the invention are generally chosen from those in which each R independently represents an alkyl group containing from 5 to 18 carbon atoms. They are preferably chosen from those in which each R independently represents an alkyl group containing from 6 to 12 carbon atoms, more particularly from those containing from 6 to 10 carbon atoms. The trialkyl-aluminiums (b) in which each R represents a linear alkyl group are very particularly preferred. Tri-n-hexylaluminium (THA) is most particularly preferred.

The catalytic system used in the process according to the invention is substantially free of aluminoxanes. Advantageously, it does not comprise any ionizing agents such as triphenylcarbenium tetrakis(pentafluoro-phenyl)borate, N,N-dimethylanilium tetrakis(penta-fluorophenyl)borate, tri(n-butyl)ammonium tetrakis-(pentafluorophenyl)borate, tris(pentafluorophenyl)-boron, triphenylboron, trimethylboron, tris(trimethyl-silyl)boron and organoboroxines. The catalytic system used in the process according to the invention may optionally contain organoaluminium compounds other than the trialkylaluminium (b).

The amount of trialkylaluminium (b) used in the process according to the invention is generally such that the atomic ratio of the aluminium originating from the trialkylaluminium (b) to the transition metal originating from the catalytic complex (a) is from 1 to 20 000. Preferably, this ratio is at least 2. Usually, the amount of alkylaluminium used is such that the atomic ratio of the aluminium to the transition metal is not more than 15 000 and more particularly not more than 10 000.

In the process according to the invention, the trialkylaluminium (b) may be placed in contact with the α-olefin in the polymerization reactor, before adding the catalytic complex (a) thereto. As an alternative, only some of the trialkylaluminium (b) is placed in contact with the α-olefin in the polymerization reactor; the other portion is used to make a premix with the catalytic complex (a). One variant consists in making a premix of the catalytic complex (a) with the trialkylaluminium (b), and then in placing it in the polymerization reactor in the presence of the α-olefin.

The catalytic system used in the process according to the invention may contain a carrier. The carrier may be any organic or inorganic solid know in the art for supporting components like constituent (a) and/or constituent (b) of the catalytic system.

The polymerization process according to the invention may be performed in continuous or batchwise mode, according to any known process, especially in solution or suspension in a hydrocarbon diluent, in suspension in the monomer, or one of the monomers, maintained in the liquid state, or alternatively in the gaseous phase.

Optionally, the polymerization process according to the invention may be carried out in the presence of one or more agents for controlling the molecular mass of the polyolefins, such as hydrogen. The process according to the invention may also be carried out by adding one or more anticaking agents and/or one or more poison scavengers such as organolithium, oganomagnesium, organozinc, organoaluminium or organotin derivatives.

The temperature at which the polymerization process according to the invention is carried out is generally from −50° C. to +300° C. and usually from −20 to 130° C. The polymerization temperature is preferably at least 30° C. Preferably, it does not exceed 115° C.

The total pressure at which the process according to the invention is carried out is generally chosen to be between 1 ×10⁵ and 100 ×10⁵ Pa and more particularly between 1 ×10⁵ and 55 ×10⁵ Pa.

The polymerization process according to the invention is advantageously applied to the manufacture of ethylene polymers, and more particularly to the manufacture of ethylene homopolymers and copolymers comprising at least 90 mol% of units derived from ethylene. The preferred copolymers are those of ethylene and of another α-olefin containing from 3 to 8 carbon atoms. Copolymers of ethylene and of 1-butene and/or of 1-hexene are particularly preferred. In this case, the polymerization process is preferably formed in suspension in a hydrocarbon diluent. The hydrocarbon diluent is generally chosen from aliphatic hydrocarbons containing from 3 to 10 carbon atoms. Preferably, the diluent is chosen from propane, isobutane and hexane, or mixtures thereof.

The process according to the invention gives α-olefin polymers with high activities, generally at least equivalent to those obtained using aluminoxanes. The process according to the invention generally makes it possible to obtain high catalytic activities, even using atomic ratios of aluminium to the metal (M) that are less than those generally used with aluminoxanes.

The following examples serve to illustrate the invention. The methods for measuring the magnitudes mentioned in the examples, and the meaning of the symbols used in these examples are explained below.

The number-average molecular masses (Mₙ) and weight-average molecular masses (M_{w}) are obtained by steric exclusion chromatography using a solution of polymer in trichlorobenzene, at 0.5 g/l, using a polystyrene column such as the Waters STYRAGEL® HMW 6E column sold by Waters Co. Ltd. The molecular mass distribution (MWD) is characterized by the ratio of M_{w}/Mₙ.

The catalytic activity is characterized by the amount of polymer formed during the polymerization tests and is expressed as kg of polymer per mole of transition metal used, per hour of polymerization and per 105 Pa.

### Examples 1 to 3

100 ml of toluene were added to a 300 ml autoclave, conditioned beforehand under nitrogen. The autoclave was brought to 30° C. and placed under vacuum for 5 minutes. Ethylene was then added thereto until a pressure of 1 ×10⁵ Pa was obtained. The amount of trialkylaluminium (b) required to achieve the Al/Fe atomic ratio indicated in Table 1 was introduced into the reactor.

This mixture was then stirred before starting the polymerization by introducing 0.8 ×10⁻³ mmol of the catalytic complex

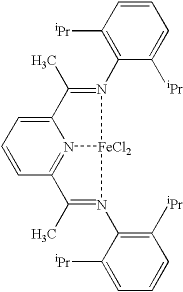

The temperature and pressure were kept constant for one hour. The polymerization was stopped by degassing the ethylene. The reactor contents were emptied out into a beaker containing 100 ml of methanol.

S 300 ml of toluene were added to the reactor and stirred for 2 hours at 100° C. under 5 ×10⁵ Pa of nitrogen in order to dissolve therein the polymer remaining in the reactor. This toluene was then added to the same beaker. A large excess of acetone and 5 ml of concentrated HCl diluted in 50 ml of water were added to the 600 ml of toluene so as to precipitate the polymer therein and to destroy the catalyst and co-catalyst present. The precipitated polymer was filtered off and dried to constant weight.

S The results obtained are given in Table 1 below.

### Example 4R (not in accordance with the invention)

S The operations of Example 1 were repeated, except that the THA was replaced with methylaluminoxane (MAO) . The Al (originating from the MAO)/Fe atomic ratio was equal to 1 000.

S The results obtained are-given in Table 1 below.

Comparison of Example 1R with Example 1 shows that the process according to the invention makes it possible to obtain a catalytic activity comparable to that obtained with the same catalytic system and MAO, but with a markedly lower Al/Fe atomic ratio.

### Example 5R (not in accordance with the invention)

The operations of Example 4R were repeated, except that the MAO was replaced with TMA.

The results obtained are given in Table 1 below.

### Example 6R (not in accordance with the invention)

The operations of Example 1 were repeated, except that the THA was replaced with TIBAL.

The results obtained are given in Table 1 below.

Comparison of the results obtained in Comparative Examples 5R and 6R with those of Examples 1 to 3 shows that the process according to the invention using a trialkylaluminium (b) makes it possible to obtain a higher catalytic activity compared with a catalytic system comprising the same catalytic complex and a trialkylaluminium with a short alkyl chain.

TABLE 1

| | | | Activity (kg PE/mol | | |
|---|---|---|---|---|---|
| Ex. | Trialkyl Al (b) | Al/Fe (mole/mole) | Fe.10⁵ Pa.h) | Mw (10³ daltons) | MWD |
| 1 | THA | 250 | 3 250 | 167 | 4.5 |
| 2 | THA | 500 | 3 000 | 252 | (bimodal) |
| 3 | THA | 600 | 2 840 | 179 | (bimodal) |
| 4R | (MAO) | 1 000 | 3 400 | — | — |
| 5R | (TMA) | 1 000 | 87 | — | — |
| 6R | (TIBAL) | 250 | 2 125 | 134 | 2.5 |

1. Process for polymerizing α-olefins, in which at least one α-olefin is placed in contact, under polymerizing conditions, with a catalytic system comprising
(a) at least one catalytic complex based on a metal (M) from groups 6 to 12 of the Periodic Table,
(b) at least one trialkylaluminium corresponding to the general formula AlR₃ in which each R independently represents an alkyl group containing from 5 to 30 carbon atoms.

2. Process according to claim 1, in which the catalytic complex (a) corresponds to the general formula (II) 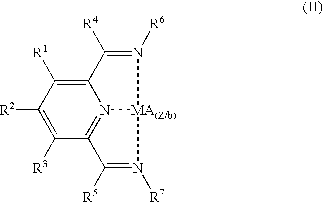
in which
M is a metal from groups 6 to 12 of the Periodic Table,
each A independently represents an atom or a group of atoms covalently or ionically bonded to the metal M,
Z is the oxidation state of M,
b is the valency of A,
R¹, R², R³, R⁴ and R⁵ each independently represent a hydrogen atom, an optionally substituted hydrocarbon group, an optionally substituted heterohydrocarbon group or an inert functional group,
R⁶ and R⁷ each independently represent an optionally substituted aryl group.

3. Process according to claim 2, in which the catalytic complex corresponds to formula (II) in which
R⁶ is an aryl group of general formula 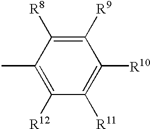
and R⁷ is an aryl group of general formula 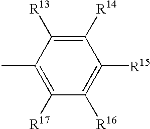
in which
R⁸ and R13 each independently represent an optionally substituted hydrocarbon group, an optionally substituted heterohydrocarbon group or an inert functional group,
R⁹ , R¹⁰ , R¹¹ , R¹² , R¹⁴, R₁₅ ,R¹⁶ and R¹⁷ each independently represent a hydrogen atom, an optionally substituted hydrocarbon group, an optionally substituted heterohydrocarbon group or an inert functional group,
R⁸,R⁹, R¹⁰, R¹¹, R¹², R¹³, R¹⁴, R¹⁵, R¹⁶ and R¹⁷ which are adjacent possibly being linked together so as to form a ring.

4. Process according to claim 2, in which the catalytic complex (a) corresponds to formula (II) in which
M is an Fe atom,
A is a Cl atom,
b is equal to 1,
Z is equal to 2,
R¹, R² and R³ are hydrogen atoms,
R⁴ and R⁵ are each independently a hydrogen atom or an alkyl group containing from 1 to 6 carbon atoms,
R⁶ is an aryl group of formula 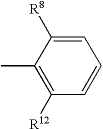
R⁷ is an aryl group of formula 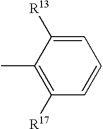
in which R⁸ and R¹³ are an alkyl group containing not more than 4 carbon atoms,
and R¹² and R¹⁷ are a hydrogen atom or an alkyl group containing not more than 4 carbon atoms.

5. Process according to claim 1, in which the trialkylaluminium (b) corresponds to the general formula AlR₃ in which each R independently represents an alkyl group containing from 6 to 12 carbon atoms.

6. Process according to any claim 1, in which each R independently represents a linear alkyl group.

7. Process according to claim 1, in which the trialkylaluminium (b) is tri-n-hexylaluminium.

8. Process according to claim 1, in which the atomic ratio of the aluminium originating from the trialkylaluminium (b) to the transition metal (M) originating from the catalytic complex (a) is from 1 to 20 000.

9. Process according to claim 1, in which the polymerization is carried out at a temperature of from −50 to 300° C. and at a pressure of from 1 to 100 ×10⁵ Pa.

10. Process according to claim 1, applied to the manufacture of ethylene homopolymers or copolymers comprising at least 90 mol% of units derived from ethylene.
